(19) United States
(12) Patent Application Publication
(10) Pub. No.: US 2003/0165353 A1
(43) Pub. Date: Sep. 4, 2003

(54) Joining system for fast assembly structures of variable size

(76) Inventor: Carlos Clausell, Xochimilco (MX)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/296,397

(22) PCT Filed: May 29, 2001
(86) PCT No.: PCT/IB01/00948

(30) Foreign Application Priority Data
Jun. 2, 2000 (MX) 005443

(51) Int. Cl. F16C 11/06

(52) U.S. Cl. 403/56

(57) ABSTRACT

The present invention relates to a joining system for fast assembly structures of variable size, with which different size spaces are covered, the structures of the present invention can be two-dimensional or three-dimensional; these structure magnitudes vary in a very wide range. The joining system for structures of the present invention is essentially integrated by: a tubular element in which a bushing penetrates; a spherical head screw and a node where the screw is screwed. The spherical head when coupling the bushing makes possible a more functional structure assembly and the degree of freedom the system has during its assembly stage increase considerably due to the angles in which the tubular element can be placed with respect to the node are very wide, the aforesaid allows the structure assembly in a very diverse size range. The joining system of the present invention bases part of its functioning and effectiveness on the joint action of this couple of elements screw-bushing and on their structure matching.

### BACKGROUND OF THE INVENTION

1. Field of the Invention

The present invention relates to a joining system for fast assembly structures of variable size, which cover different size spaces, the structures of the present invention can be two-dimensional or three-dimensional, they could comprise a very wide size range.

2. Description of Related Art

Currently there is in the market a great diversity of building structural systems, most of them are complex and difficult to assembly, requiring sophisticated machinery or tools, as well as a considerable amount of skilled labor for said assembly, which as may be supposed, represents an important disadvantage for this kind of structures.

Among the conventional structure systems, there are the metallic ones and the plastic ones for scale patterns, particularly there are some of them formed by pieces composed by folded, solid, extruded or welded profiles, joined one to an other by screw and nut, pressure or welding. These systems also count with fixing elements from though holes for rivet or fixing elements.

As it is evident from the aforesaid, these systems present great disadvantages, for example: They are difficult to reuse; difficult to assembly and present large limitations as to the structure types, as well as the size they can be shaped, being the last one a severe limitation for their use.

Other disadvantage of the current systems is that they only function for a determined structure type since their elements present rigidity respect to the angle value adopted during the assembly process and in the structure once it is constructed, that is, they can be used or not depending on the structure size to be constructed, being thus limited as to their application with respect to the market needs.

Recently there have been advances in the constructive systems of these systems, as an example of the before mentioned, there is the invention granted as Mexican Patent No. 1,668,933, owned by the same owner of the present application.

In said patent it is described and claimed a structure system consisting uniquely of two pieces: a connector that can be named as node and a tubular separator bar of different diameters and thickness.

The separator piece is a bar of different length that can adopt any round, square, hexagonal, etc. section, solid or tubular with sharp end (tongue and groove joint) for fixing the screw pass that by an hexagonal piece joins the bar to the node, having the screw a bolt allowing the hexagonal piece slack.

Another example of the advance reached in this matter is represented by the invention contained in Mexican Patent No. 188,650, owned by the inventor of the present application. Said patent refers to a joining system for fast assembly structures which consist of polyhedron shape connectors or nodes with threaded perforations in their square faces; lineal segments which can be tubular; an bushing housed inside and abutting against the tubular segment end; an screw with stem which is also partially housed also inside the same tubular segment end, protruding part of its stem and all the thread; a nut positioned in the part of the screw stem, having the stem and the nut perforation the same irregular design, so that when manually or by a tool the nut rotates, the screw will rotate so as to thread into one of the node perforations.

### SUMMARY OF THE INVENTION

The present invention provides a joining system for fast assembly structures of variable size, which incorporates improved aspects in the joining mechanism of the tubular section or other geometry to the node or connector with thread perforations.

Thus one of the objects of the present invention is to provide a joining system of fast assembly structures in which its conforming elements can adopt during its constructions a wide angle value range which allows assembling variable size structures, from the very small ones up to the great size ones.

Another object of the present invention is constituted for the improved tubular section -node joining system in a fast assembly structure.

A further object of the present invention consist in providing a system whereby a very different type structures can be assembled either two-dimensional or three-dimensional.

### BRIEF DESCRIPTION OF THE DRAWINGS

In order to illustrate conveniently the present invention, following a detailed description thereof is given, which is accompanied by several figures illustrating some preferred embodiments of the system, but of course, they should not be considered limitative.

FIG. 1 shows a perspective view of the elements conforming the joining system for fast assembly structures, which is illustrated unassembled.

FIG. 2 refers to a sectional view of a system tubular end part housing a screw with spherical head

FIG. 3 corresponds to a pictorial view of 3 terminals in different steps of assembly and joining to a connector or node.

FIG. 4 shows a perspective view of the spherical head screw and its corresponding nut.

FIG. 5 illustrates in perspective a basic module constituted by 5 nodes and 8 lineal segments for assembling a three-dimensional structure.

### DETAILED DESCRIPTION OF THE PREFERRED EMBODIMENT

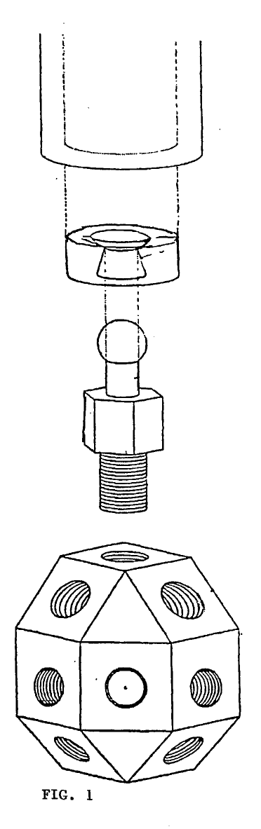

Referring to the previous figures, with respect to what is illustrated in FIG. 1, the joining system for structures of the present invention is essentially conformed by: a tubular element (1), in which a bushing (2) penetrates; a spherical head screw (3) and a node (4) where the screw (3) is threaded.

As can be appreciated from the previous figure, the bushing (2) has a cylindrical structure of reduced height (5), with a semispherical cavity (6) in the central part of one of the cylindrical structure faces terminating in a perforation (7), the semispherical cavity comprises part of the cylindrical structure height, from the perforation and comprising the rest of the cylindrical structure height, the perforation continues broaden the diameter thereof, forming a section (14), which ends in the other cylindrical structure face.

The spherical head screw (3) has besides the spherical head (8), a thread (9), English standard or special, it is also constituted by an integrated nut (10),having no free spinning with respect to the screw body, which can be hexagonal and it is located between the thread and the spherical head, contiguous to the thread and separated from the spherical head by an screw smooth section (11). Likewise node (4) is observed with its perforations (13).

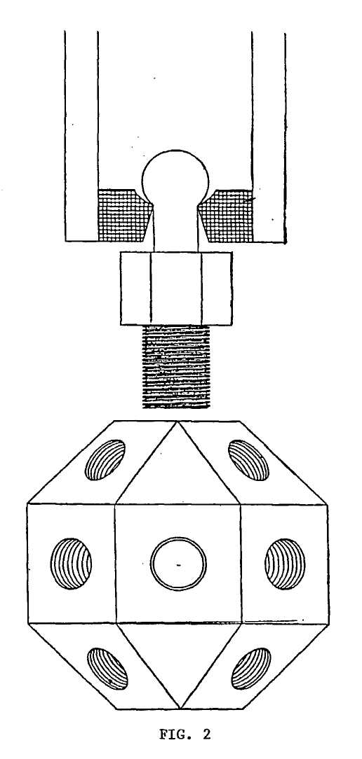

A joining system assembly process for structures is shown in FIG. 2; screw (3) is placed in a position where bushing (2)is already housed; on the other hand it is shown that spherical head (8) of screw (3) and bushing (2), are located within tubular element 1), likewise it is shown that bushing (2) is fixed to the extreme inner wall (12) of tube (1); nut (10) is illustrated in its fixed position to screw (3), which is about to be threaded within one of the threaded perforations (13) of node (4).

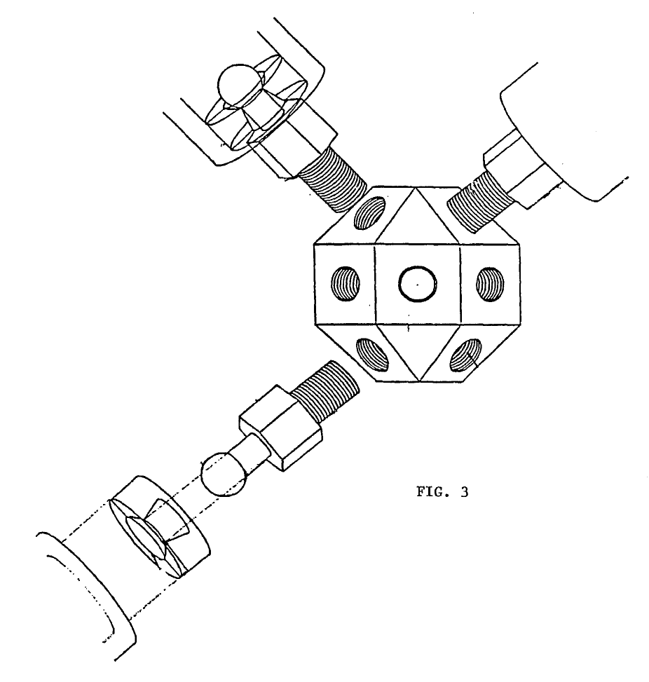

FIG. 3 shows the joining system for fast assembly structures of variable size in several steps of its assembly process to node (4). Referring to the upper right part of FIG. 3, the following joining system elements are shown: tubular element (1), bushing (2) with its semispherical cavity (6), as well as perforation (7), spherical head (8), nut (10) and thread (9). As it can be observed, screw (3) has not been placed yet within bushing perforation (4) and both elements are out of the tubular element (1).

In the bottom right part of FIG. 3, the same pieces before mentioned are illustrated but in a more advanced stage of the assembly process of the joining system for structures of the present invention; thereby screw (3), is already placed within the bushing (2) perforation, as well as in the inner extreme of the tubular element (1); protruding only nut (10) from the tubular element extreme, and thread (9) being about to penetrate into threaded perforation (13) of node (4), thereby completing the joining system assembly process. It is clearly observed that the bottom of the screw spherical head is housed inside the bushing cavity and the screw smooth cylindrical part crosses the perforation in the cavity bottom and the section with the broaden perforation of said bushing.

In the bottom left part of FIG. 3, it is shown the final stage of the joining system assembly for structures claimed in the present application, illustrating only the parts which could be seen from the exterior and which are tubular element (1), nut (10) part of the thread (9) and node (4).

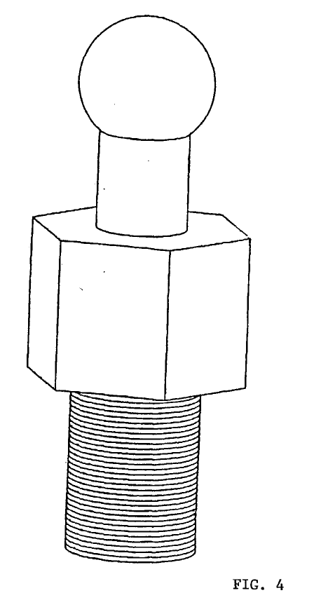

FIG. 4 clearly illustrates one of the outstanding elements of the present invention, which corresponds to screw (3) with its spherical head (8), smooth section (11), nut (10) and thread (9). The combination of the screw (3) structure with bushing (2), corresponds to other outstanding aspect of the present invention since spherical head (8), when coupling bushing (2), by the semispherical section structure (6) and perforation (7) with its perforated, widened or divergent section (14), makes possible a more functional structure assembly and the degree of freedom the system has during the assembly stage increases considerably because the angles in which the tubular element (1) can be placed with respect to node (4) are very wide, the aforementioned allows assembling a wide size range structures. The joining system of the present invention bases part of its functioning and effectiveness on the joint action of both elements screw-bushing and on the matching of their structures.

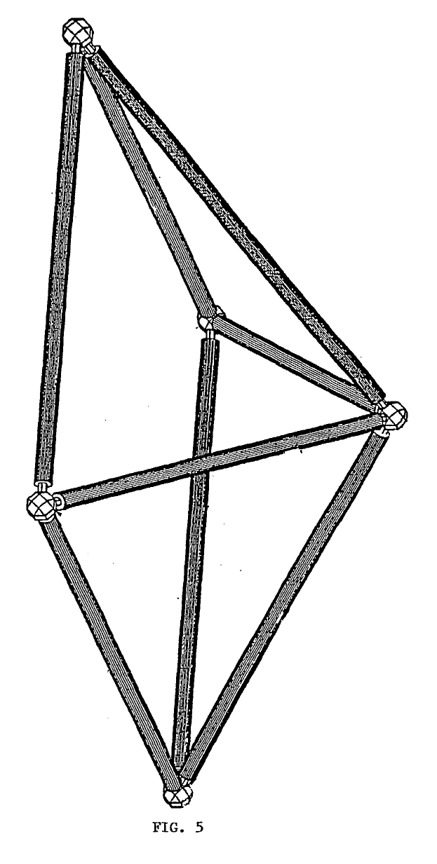

In FIG. 5 appears a basic module which consist of 5 nodes (4) and 8 bars or tubular elements (1), this module serves to assembly three-dimensional structures, by repeating or joining the same with other similar ones, of course, following the assembly process associated to the system of the present invention which will be described later, as before mentioned, said basic module is constituted by 5 nodes from which 4 are lower and one is upper, as well as by 4 lower tubular segments and four upper tubular segments.

With respect to some outstanding characteristics of the parts conforming the joining system for fast assembly structures, it can be said:

The node is a solid piece with polyhedron shape having 18 equal square faces, as well as eight regular triangular faces. Round perforations are located on the square faces, with variable diameter thread according to square side, the thread deepness will be equal to the perforation diameter, this node can be made of metallic or plastic material.

According to the polyhedron square side, the node measure can be of different sizes, for example, 0.05 cm., 1 cm., 1.5 cm., 2 cm., 2.5 cm., 3 cm., 4 cm., 4.5 cm., y 5 cm.

Likewise, auger perforations for 0.05 cm., 1 cm., and 1.5 cm. polyhedrons, will be from 3 mm. to 6 mm. threaded piercing and for 2 cm., 2.5 cm., and 3 cm. polyhedrons, will be 12.7 mm (1/22) and 12.7 mm threaded piercing.

For the circular perforations of the nodes having 3.5 cm., 4 cm., 4.5 cm., and 5 cm. square face, will be 19 mm diameter (¾″) and 19 mm threaded.

Materials for manufacturing the nodes and bars can be for example rigid plastics (thermoplastics), metallic (iron, steel, aluminum, bronze, zinc, lead, etc.) and still rubbers.

Node manufacturing can be carried out by, machining, welding, casting, pour, blowing, and injection.

Tubular element or bar manufacturing can be: tubular (in any of their shapes: round, square, hexagonal, etc.) solid, extruded, injected, folded, welded, casted or poured, and can be constructed with metallic or plastic materials.

Screw (3) can be from ¼ (0.63 cm) to 2″ (5.08 cm) thickness, nut (10) is octagonal, square or any other geometric shape, regular or irregular, this nut is firmly fixed to the screw body (3) so that when turning round the nut by the applied power manually or by a proper tool, likewise all the screw will turn round, so that it will be possible to hold it up and thus tubular element (1) to node (4). Nut measures can be from ⅛″ (0.31 cm) to 4″ (10.16 cm) or more, the screw can be constructed with metallic or plastic materials.

Pieces placing correspond to a logic arrangement and there is no other formation possibility.

According to the system of the present invention, the process for an structure assembling is other of the remarkable characteristic aspects thereof, since manually or with a sole tool it is possible to construct a great diversity of different kind of structures either for example the three-dimensional type ones or the two-dimensional type ones, also named membranes.

Structure assembly using the system of the present invention is carried out as follows: A tube (1) which will form part of said structure is chosen. Taking into account the bushing structure as well as the condition that the same must be firmly joined to the inner extreme wall of tubular element (1) in order to spherical screw once it is placed into the tubular element extreme, it can effect a turning or shifting movement within a very wide angle range, but provided that it can not get out from tubular element nor get inserted in the same, firstly it is necessary to place spherical head (8) of screw (3) into the tube, following and in order to place the bushing in the before mentioned position, firstly a part thereof is inserted which corresponds to half of said bushing, therefore it is understood that previously bushing (2) is formed in two symmetric sections throughout a vertical plane, joining the first part to the extreme inner wall of tubular element (1), which can be effected by welding or by other joining element such as riveting, finally the other part of bushing (2) is placed in an aligned form with the first part or section thereof, proceeding to the same fixing operation as before indicated, because of which the bushing and the screw stand assembled in their working position since on one hand the screw nut abuts the bushing outer extreme due to nut measures are greater than the bushing broaden section ones and on the other hand, inside the tube, the spherical head abut against perforation in the bushing inner extreme at the semispherical cavity bottom in which part of the spherical head is housed, having screw free spinning and shifting liberty during its assembling stage in a very wide tubular element angle value range with respect to the node, under these/circumstances it will be possible to secure in the threaded perforation chosen from a node (4); for screwing screw (3), it will be sufficient to manually screw nut (10), to tighten the screw, if necessary, a tool can be used.

As it is easy to see, the present system has a great versatility for obtaining different structure forms.

Having sufficiently described my invention, I consider it a novelty and so that,

I claim as my exclusive property the content of the following:

1. Joining system for fast assembly structures of variable size which comprises polyhedron shaped connectors or nodes having 18 equal square faces, as well as eight regular triangular faces. In the square faces threaded round perforations are located having variable diameter according to side of the square, characterized in that it consists of spherical head screws having an integrated nut; an bushing having a reduced height cylindrical structure, with a semispherical cavity in the central part of one of the cylindrical structure faces and a divergent broaden section ending in the other cylindrical structure face. When the screw is in the assembled position, it is partially located inside the tubular element and the bushing is fixed to the extreme inner wall of said tubular element, protruding from the tube part of the screw body, the nut and the threaded section; the assembled spherical head freely rotates and the screw can effect shifts during its assembling stage, in a very wide angle value range of the tubular element with respect to the node, which are constructed with metallic or plastic materials.

2. Joining system for fast assembly structures of variable size, according to claim 1, characterized by a screw comprising an spherical head followed by a cylindrical section having a smooth surface, at the end of this section there is a nut, which is integrated to the screw body without having free rotation with respect to the screw body and a threaded section in order that the screw can be screwed in the node, which is constructed with metallic or plastic materials.

3. Joining system for fast assembly structures of variable size, according to claim 1, characterized in that the bushing has a reduced height cylindrical structure, with a semispherical cavity in the central part of one of the cylindrical structure faces, having a perforation at the bottom of the semispherical cavity, this cavity comprises part of the cylindrical structure height, from the perforation and comprising the rest of the cylindrical structure height, the perforation diameter continues broadening to form a section ending in the other cylindrical structure face, which is constructed with metallic or plastic materials.

4. Joining system for fast assembly structures of variable size, according to claim 1, characterized in that under its working assembled condition on one hand, the screw nut abuts against the bushing outer extreme due to the nut measures are greater than ones of the bushing broadened perforated section and on the other hand, inside the tube the spherical head abuts against the bushing inner extreme perforation at the bottom of the semispherical cavity, in which the spherical head is partially housed, the screw having free rotation and the shifts liberty during its assembling stage in a very wide angle value range of the tubular element with respect to the node, these elements are constructed with metallic or plastic materials.

5. Joining system for fast assembly structures of variable size, according to claim 1, characterized in that to assemble a structure is carried out in the following form: A tube is chosen, which will be part of said structure, the screw spherical head is inserted inside the tube in one of their extremes, next and in order to place the bushing joined to the tube inner wall, firstly a part thereof is inserted which corresponds to one of the two symmetrical sections throughout a vertical plane in which the bushing was previously divided, fixing the first part to the tubular element extreme inner wall, for example by welding, after that the other bushing part is placed, in aligned form with respect to the first part or section thereof, proceeding to make the same fixing operation, with which the bushing and the screw stand assembled in their working position, after that, the screw is screwed in the node perforation, making the nut to rotate, which is effected manually or assisted by a tool, repeating this operation all the necessary times.
